(19) United States
(12) Patent Application Publication
(10) Pub. No.: US 2022/0137187 A1
(43) Pub. Date: May 5, 2022

(54) OBJECT DETECTION APPARATUS

(71) Applicant: TOYOTA JIDOSHA KABUSHIKI KAISHA, Toyota-shi (JP)

(72) Inventors: Sadayuki ABE, Sunto-gun (JP); Yusuke HAYASHI, Susono-shi (JP); Taichi KAWANAI, Susono-shi (JP)

(73) Assignee: TOYOTA JIDOSHA KABUSHIKI KAISHA, Toyota-shi (JP)

(21) Appl. No.: 17/490,032

(22) Filed: Sep. 30, 2021

(30) Foreign Application Priority Data
Oct. 29, 2020 (JP) 2020-181698

(51) Int. Cl. G01S 7/48; G01S 17/89; G01S 17/86; G01S 17/08

(52) U.S. Cl. CPC G01S 7/4808; G01S 17/08; G01S 17/86; G01S 17/89

(57) ABSTRACT

An object detection apparatus includes: a laser light irradiation unit; a light reception element configured to detect reflection light of the laser light and reflection light of ambient light which is light other than the laser light; a camera; an information correction unit configured to generate corrected ambient light information by correcting ambient light information, which is information about the reflection light of the ambient light detected by the light reception element, based on a camera image; an object detection unit configured to detect an object target, based on the corrected ambient light information and laser light information received by the light reception element.

### CROSS-REFERENCE TO RELATED APPLICATION

This application claims the benefit of priority from Japanese Patent Application No. 2020-181698, filed on Oct. 29, 2020, the entire contents of which are incorporated herein by reference.

### TECHNICAL FIELD

The present disclosure relates to an object detection apparatus.

### BACKGROUND

For example, the autonomous driving vehicle is equipped with a LIDAR that detects an object target based on the reflection light of the irradiated laser light in order to detect the surrounding object target. Further, for example, as described in the following non-patent literatures, a LIDAR, which detects an object target by using the reflection light of the irradiated laser light and the result of detection of the reflection light of the ambient light other than the irradiated laser light, has been developed.

Non-Patent Literatures: Seigo Ito, Masayoshi Hiratsuka, Mitsuhiko Ota, Hiroyuki Matsubara, Masaru Ogawa “Localization Method based on Small Imaging LIDAR and DCNN” Information Processing Society of Japan, The 79th National Convention Lecture Proceedings

In the LIDAR, the same light reception element receives the reflection light of the laser light and the reflection light of the ambient light. Thus, as the results of detection of both, a positional correspondence relationship with each other is obtained. Therefore, by using such a LIDAR, it is possible to detect an object target, based on the results of detection of two types of light having the positional correspondence relationship.

### SUMMARY

In general, the number of light reception elements in the light reception unit of the camera is extremely larger than the number of light reception elements in the light reception unit of the LIDAR. Therefore, the amount of ambient light information acquired by the LIDAR is smaller than the amount of information in the camera image captured by the camera, and the amount of information is small to accurately detect the object target. Therefore, in a case where the result of detection of the reflection light of the ambient light is used in addition to the reflection light of the laser light, there is room for improvement in order to detect the object target with higher accuracy.

Therefore, the present disclosure describes an object detection apparatus capable of accurately detecting an object target based on the results of detection of the reflection light of the laser light and the reflection light of the ambient light.

According to an aspect of the present disclosure, there is an object detection apparatus including: a laser light irradiation unit configured to illuminate laser light; a light reception unit configured to detect reflection light of the laser light and reflection light of ambient light which is light other than the laser light; a camera; an information correction unit configured to generate corrected ambient light information by correcting ambient light information which is information about the reflection light of the ambient light detected by the light reception unit based on a camera image captured by the camera; an object detection unit configured to detect an object target, based on the corrected ambient light information and laser light information which is information about the reflection light of the laser light received by the light reception unit.

The object detection apparatus corrects the ambient light information based on the camera image, thereby generating the corrected ambient light information. Then, the object detection apparatus detects the object target, based on the generated corrected ambient light information and the laser light information. In such a manner, the object detection apparatus is able to accurately detect the object target based on the result of detection of the reflection light of the laser light and the reflection light of the ambient light (the laser light information and the corrected ambient light information) by using the corrected ambient light information which is obtained by correcting the ambient light information based on the camera image.

In the object detection apparatus, the information correction unit may generate the corrected ambient light information by adding color information of the camera image to the ambient light information. In such a case, the information correction unit is able to increase the number of color channels of the ambient light information. As a result, the object detection apparatus is able to more accurately detect the object target by using the corrected ambient light information, to which the color information of the camera image is added, and the laser light information.

In the object detection apparatus, the information correction unit may generate the corrected ambient light information by adding information of the camera image between pixels of the ambient light information. In such a case, the information correction unit is able to increase the resolution of the ambient light information. As a result, the object detection apparatus is able to detect the object target with higher accuracy by using the corrected ambient light information with the increased resolution and the laser light information.

In the object detection apparatus, the information correction unit may correct the ambient light information based on segmentation information obtained from the camera image to generate the corrected ambient light information. In such a case, the object detection apparatus is able to detect the object target more accurately by using the corrected ambient light information generated based on the segmentation information and the laser light information.

In the object detection apparatus, the information correction unit may generate the corrected ambient light information by calculating a distance to a reflection point of the ambient light obtained based on a disparity between the camera image and the ambient light information and by adding calculated distance information to the ambient light information. In such a case, the object detection apparatus is able to more accurately detect the object target by using the corrected ambient light information, to which the information of the distance to the reflection point of the ambient light is added, and the laser light information.

According to the aspect of the present disclosure, the object target can be accurately detected, based on the result of detection of the reflection light of the laser light and the reflection light of the ambient light.

### BRIEF DESCRIPTION OF THE DRAWINGS

FIG. 1 is a block diagram showing an example of an object detection apparatus according to an embodiment.

FIG. 2 is a flowchart showing the flow of the object target detection processing performed in the object detection ECU.

### DETAILED DESCRIPTION

Hereinafter, exemplary embodiments will be described, with reference to the drawings. In each drawing, the same or corresponding elements are represented by the same reference numerals, and repeated description will not be given.

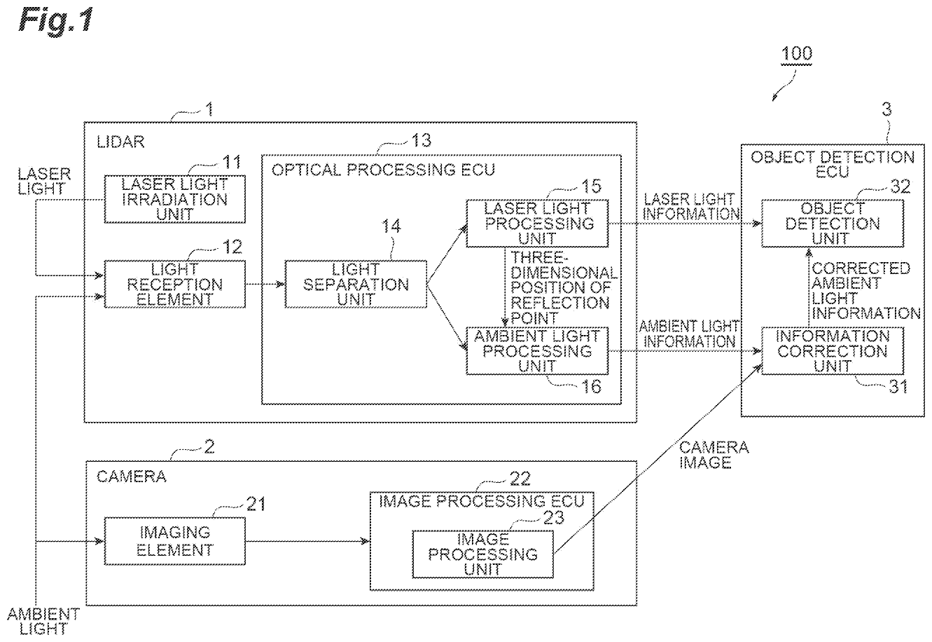

As shown in FIG. 1, the object detection apparatus 100 is mounted on a vehicle (host vehicle) and detects an object target around the host vehicle. The object target detected by the object detection apparatus 100 can be used for various controls such as autonomous driving of the host vehicle. The object detection apparatus 100 includes a light detection and ranging (LIDAR) 1, a camera 2, and an object detection electronic control unit (ECU) 3.

The LIDAR 1 irradiates the surroundings of the host vehicle with laser light, and receives the reflection light (reflection light of the laser light) reflected by the irradiated laser light on the object target. Further, the LIDAR 1 detects the intensity of the reflection light of the laser light. In addition to the reflection light of the irradiated laser light, the LIDAR 1 in the present embodiment is able to receive the reflection light (reflection light of the ambient light) reflected by the ambient light, which is the light other than the irradiated laser light, on the object target. Further, the LIDAR 1 is able to detect the intensity of the received reflection light of the ambient light. The ambient light is, for example, sunlight and light around the host vehicle such as lighting.

More specifically, the LIDAR 1 includes a laser light irradiation unit 11, a light reception element 12, and an optical processing ECU 13. The laser light irradiation unit 11 illuminates laser light toward each position in a predetermined irradiation region around the host vehicle on which the object detection apparatus 100 is mounted.

The light reception element 12 is able to receive the reflection light of the laser light illuminated from the laser light irradiation unit 11 and output a signal corresponding to the intensity of the received reflection light of the laser light. Further, the light reception element 12 is able to receive the reflection light of the ambient light other than the laser light illuminated from the laser light irradiation unit 11, and output a signal corresponding to the intensity of the received reflection light of the ambient light.

The optical processing ECU 13 is an electronic control unit which has a CPU, ROM, RAM, and the like. The optical processing ECU 13 realizes various functions by loading, for example, the programs recorded in the ROM into the RAM and executing the programs loaded in the RAM in the CPU. The optical processing ECU 13 may be composed of a plurality of electronic units.

The optical processing ECU 13 detects each of the intensity of the reflection light of the laser light received by the light reception element 12 and the intensity of the reflection light of the ambient light, based on the output signal of the light reception element 12. The optical processing ECU 13 functionally includes a light separation unit 14, a laser light processing unit 15, and an ambient light processing unit 16. In such a manner, the light reception element 12, the light separation unit 14, the laser light processing unit 15, and the ambient light processing unit 16 function as light reception units capable of detecting the reflection light of the laser light and the reflection light of the ambient light.

The light separation unit 14 separates the light received by the light reception element 12 into the reflection light of the laser light and the reflection light of the ambient light. For example, the light separation unit 14 is able to discriminate light having a specific flickering pattern as reflection light of laser light, and discriminate other light as reflection light of ambient light. Further, for example, the light separation unit 14 is able to discriminate the light, which is received within a predetermined time after the laser light irradiation unit 11 illuminates the laser light, as the reflection light of the laser light, and discriminate the light received at other timings as reflection light of ambient light. The predetermined time is set, in advance, based on the time from in a case where the laser light irradiation unit 11 illuminates the laser light until the irradiated laser light is reflected by the object target around the host vehicle and the reflection light of the laser light reaches the light reception element 12. As mentioned above, the reflection light of the ambient light does not include the reflection light of the laser light illuminated from the LIDAR 1. However, in a case where the ambient light includes light having the same wavelength as the laser light, the reflection light of the ambient light includes the reflection light of the light having the same wavelength as the laser light.

The laser light processing unit 15 generates laser light information, based on the result of light reception of the reflection light of the laser light received by the light reception element 12. The laser light information is generated, based on the result of light reception of a plurality of laser light beams (result of light receptions of a plurality of reflection light beams) irradiated toward each position in a predetermined irradiation region. After the laser light irradiation is completed for all the positions in the irradiation region, the LIDAR 1 again illuminates the laser light toward each position in the irradiation region. In such a manner, the LIDAR 1 performs the next irradiation processing again after the irradiation processing of irradiating all the positions in the irradiation region with the laser light is completed. The laser light information is generated each time the LIDAR 1 performs the irradiation processing.

More specifically, the laser light processing unit 15 generates laser light point information by associating the three-dimensional position of the reflection point of the irradiated laser light with the intensity of the laser light for each of the plurality of laser light beams to be irradiated toward the irradiation region. The laser light processing unit 15 generates laser light information based on the plurality of generated laser light point information. The laser light processing unit 15 is able to measure the three-dimensional position of the reflection point of the laser light, based on the irradiation angle of the laser light illuminated from the laser light irradiation unit 11 and the arrival time from the irradiation of the laser light until the reflection light of the laser light reaches the light reception element 12.

The ambient light processing unit 16 generates ambient light information, which is information about the reflection light of the ambient light, based on the result of light reception of the reflection light of the ambient light received by the light reception element 12. The ambient light information is generated every time the LIDAR 1 performs irradiation processing of illuminating a plurality of laser light beams into the irradiation region, similarly to the laser light information.

More specifically, first, the ambient light processing unit 16 acquires the three-dimensional position of the reflection point of the laser light from the laser light processing unit 15. Here, in a state where the state of each part of the LIDAR 1 such as the irradiation angle of the laser light is not changed, the position of the reflection point of the laser light received by the light reception element 12 and the position of the reflection point of the ambient light are the same as each other. Therefore, the LIDAR 1 detects the intensity of the reflection light of the ambient light in the state in a case where the reflection light of the laser light is received. Thereby, it is possible to detect the intensity of the reflection light of the ambient light reflected at the same position as the reflection point of the laser light. Therefore, the ambient light processing unit 16 generates the ambient light point information by associating the three-dimensional position of the reflection point of the laser light acquired from the laser light processing unit 15 with the intensity of the reflection light of the ambient light received by the light reception element 12. The ambient light point information is generated for each of a plurality of laser light beams emitted toward the irradiation region.

The ambient light processing unit 16 generates ambient light information, based on the plurality of generated ambient light point information. That is, the ambient light processing unit 16 generates ambient light information in which the position of the reflection point of the received reflection light of the laser light (ambient light) is associated with the intensity of the received reflection light of the ambient light at each position of the reflection point.

In such a manner, the LIDAR 1 is able to generate laser light information and ambient light information, based on the result of light reception of the light reception element 12. That is, the LIDAR 1 is able to generate the laser light information and the ambient light information, based on the result of light reception of one light reception element 12. Therefore, it is not necessary to perform calibration of the laser light information and the ambient light information.

The camera 2 performs imaging of an inside of a predetermined imaging region around the host vehicle and generates a camera image which is a result of the imaging. The imaging area of the camera 2 overlaps with at least a part of the irradiation area of the laser light of the LIDAR 1. The camera 2 includes an imaging element 21 and an image processing ECU 22. The imaging element 21 is able to receive the reflection light of the ambient light reflected in the imaging region and output a signal corresponding to the received reflection light of the ambient light.

The image processing ECU 22 is an electronic control unit having the same configuration as the optical processing ECU 13. The image processing ECU 22 functionally includes an image processing unit 23. The image processing unit 23 generates a camera image by a well-known method, based on the output signal of the imaging element 21.

The object detection ECU 3 detects an object target around the host vehicle based on the result of detection of the LIDAR 1. The object detection ECU 3 is an electronic control unit having the same configuration as the optical processing ECU 13. The object detection ECU 3 may be integrally configured with the optical processing ECU 13 or the image processing ECU 22. The object detection ECU 3 functionally includes an information correction unit 31 and an object detection unit 32.

The information correction unit 31 corrects the ambient light information generated by the ambient light processing unit 16 of the LIDAR 1 based on the camera image generated by the camera 2, thereby generating the corrected ambient light information. The information correction unit 31 is able to generate the corrected ambient light information by various methods based on the camera image. In the present embodiment, the information correction unit 31 is able to generate the corrected ambient light information, based on any of the following first to fourth methods, or through a combination of two or more of the following first to fourth methods. The information correction unit 31 is able to obtain the correspondence relationship (positional correspondence relationship) between the camera image and the ambient light information by performing calibration thereof in advance or matching the feature points in a case where the corrected ambient light information is generated.

### First Method

First, a first method will be described. In the first method, the information correction unit 31 generates the corrected ambient light information by adding color information (for example, RGB information) of the camera image to the ambient light information. Thereby, for example, color information is added to grayscale ambient light information, and the number of color channels in the ambient light information increases.

### Second Method

Next, a second method will be described. In the second method, the information correction unit 31 generates the corrected ambient light information by adding the information of the camera image between the pixels of the ambient light information. Here, the information correction unit 31 is able to use the color information or the luminance information of the camera image as the information of the camera image added between the pixels of the ambient light information. In such a manner, the information correction unit 31 is able to generate the corrected ambient light information with an increased resolution of the ambient light information by adding the information of the camera image between the pixels of the ambient light information.

### Third Method

Next, a third method will be described. In the third method, the information correction unit 31 corrects the ambient light information based on the segmentation information obtained from the camera image, thereby generating the corrected ambient light information. Here, the information correction unit 31 is able to obtain segmentation information from the camera image by using various well-known methods such as semantic segmentation or instance segmentation. The information correction unit 31 is able to generate the corrected ambient light information in which the ambient light information has the category information of the region, for example, by adding the segmentation information to the ambient light information. Alternatively, the information correction unit 31 is able to generate the corrected ambient light information by correcting the pixel value of the ambient light information (for example, sharpening the boundary of the region) based on the category information of the segmentation information region.

### Fourth Method

Next, a fourth method will be described. In the fourth method, the information correction unit 31 calculates the distance to the reflection point of the ambient light obtained, based on the disparity between the camera image and the ambient light information. Here, the information correction unit 31 is able to calculate the distance to the reflection point of the ambient light, based on the principle of triangulation, as in the case of a stereo camera or the like. Then, the information correction unit 31 generates the corrected ambient light information by adding the calculated distance information to the ambient light information. Thereby, the information correction unit 31 is able to generate corrected ambient light information including information about the distance to the reflection point of the ambient light.

The object detection unit 32 detects an object target, based on the corrected ambient light information generated by the information correction unit 31 and the laser light information generated by the laser light processing unit 15. Here, the object detection unit 32 is able to perform the object target detection processing and the recognition processing by various well-known methods by fusing two pieces of information including the corrected ambient light information and the laser light information.

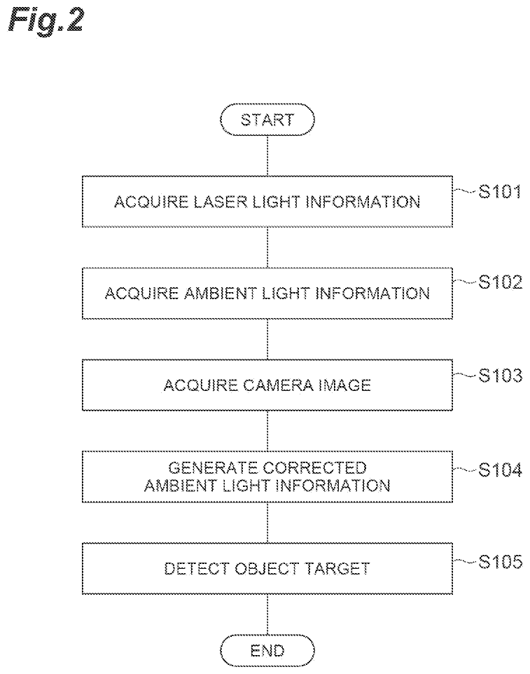

Next, an example of the flow of the object target detection processing performed by the object detection ECU 3 of the object detection apparatus 100 will be described with reference to the flowchart of FIG. 2. The detection processing shown in FIG. 2 is repeatedly executed at predetermined time intervals after the start of the object target detection processing. Further, the processing order of S101 to S104 is not limited to the order shown in FIG. 2.

As shown in FIG. 2, the object detection unit 32 acquires the laser light information generated by the laser light processing unit 15 of the LIDAR 1 (S101). The information correction unit 31 acquires the ambient light information generated by the ambient light processing unit 16 of the LIDAR 1 (S102). Further, the information correction unit 31 acquires the camera image generated by the camera 2 (S103).

The information correction unit 31 corrects the ambient light information based on the acquired camera image, thereby generating the corrected ambient light information (S104). The object detection unit 32 detects the object target, based on the acquired laser light information and the corrected ambient light information generated by the information correction unit 31 (S105).

As described above, the object detection apparatus 100 corrects the ambient light information based on the camera image, thereby generating the corrected ambient light information. Then, the object detection apparatus 100 detects the object target, based on the generated corrected ambient light information and laser light information. In such a manner, the object detection apparatus 100 is able to accurately detect the object target based on the result of detection of the reflection light of the laser light and the reflection light of the ambient light (the laser light information and the corrected ambient light information) by using the corrected ambient light information which is obtained by correcting the ambient light information based on the camera image.

In the first method of generating the corrected ambient light information, the information correction unit 31 generates the corrected ambient light information by adding the color information of the camera image to the ambient light information. In such a case, the information correction unit 31 is able to increase the number of color channels of the ambient light information. Thereby, the object detection apparatus 100 is able to more accurately detect the object target by using the corrected ambient light information, to which the color information of the camera image is added, and the laser light information.

In the second method of generating the corrected ambient light information, the information correction unit 31 generates the corrected ambient light information by adding the information of the camera image between pixels of the ambient light information. In such a case, the information correction unit 31 is able to increase the resolution of the ambient light information. Thereby, the object detection apparatus 100 is able to detect the object target with higher accuracy by using the corrected ambient light information with increased resolution and the laser light information.

In the third method of generating the corrected ambient light information, the information correction unit 31 corrects the ambient light information based on the segmentation information obtained from the camera image, thereby generating the corrected ambient light information. In such a case, the object detection apparatus 100 is able to detect the object target more accurately by using the corrected ambient light information generated based on the segmentation information and the laser light information.

In the fourth method of generating the corrected ambient light information, the information correction unit 31 calculates the distance to the reflection point of the ambient light and adds the calculated distance information to the ambient light information, thereby generating the corrected ambient light information. In such a case, the object detection apparatus 100 is able to detect the object target more accurately by using the corrected ambient light information, to which the information of the distance to the reflection point of the ambient light is added, and the laser light information.

Although the embodiments of the present disclosure have been hitherto described above, the present disclosure is not limited to the above embodiment. The present disclosure may be modified in various ways without departing from the spirit of the present disclosure.

What is clamed is:

1. An object detection apparatus comprising:
a laser light irradiation unit configured to illuminate laser light;
a light reception unit configured to detect reflection light of the laser light and reflection light of ambient light which is light other than the laser light;
a camera;
an information correction unit configured to generate corrected ambient light information by correcting ambient light information which is information about the reflection light of the ambient light detected by the light reception unit based on a camera image captured by the camera;
an object detection unit configured to detect an object target, based on the corrected ambient light information and laser light information which is information about the reflection light of the laser light received by the light reception unit.

2. The object detection apparatus according to claim 1, wherein the information correction unit generates the corrected ambient light information by adding color information of the camera image to the ambient light information.

3. The object detection apparatus according to claim 1, wherein the information correction unit generates the corrected ambient light information by adding information of the camera image between pixels of the ambient light information.

4. The object detection apparatus according to claim 1, wherein the information correction unit generates the corrected ambient light information by correcting the ambient light information based on segmentation information obtained from the camera image.

5. The object detection apparatus according to claim 1, wherein the information correction unit generates the corrected ambient light information by calculating a distance to a reflection point of the ambient light obtained based on a disparity between the camera image and the ambient light information and by adding calculated distance information to the ambient light information.
